(19) United States
(12) Patent Application Publication
(10) Pub. No.: US 2010/0130339 A1
(43) Pub. Date: May 27, 2010

(54) CUP INSULATING SYSTEM

(76) Inventor: Mitch Junkins, Newport Beach, CA (US)

Correspondence Address: Rutan & Tucker, LLP., 611 ANTON BLVD, SUITE 1400, COSTA MESA, CA, 92626, US

(21) Appl. No.: 12/626,484

(22) Filed: Nov. 25, 2009

Related U.S. Application Data
(60) Provisional application No. 61/118,377, filed on Nov. 26, 2008.

(51) Int. Cl. B31B 49/00

(52) U.S. Cl. 493/84

(57) ABSTRACT

The present invention provides an apparatus and a system for insulating a receptacle including a cup, bottle and/or container. Additionally, the present invention provides an apparatus and a system for providing a pre-packaged, efficient and easily transported insulator which may be utilized in a single use fashion and may be easily applied to the receptacle in which it is used to insulate. Moreover, the present invention may be easily applied to the receptacle by rolling the insulator onto the receptacle. Further, the present invention may allow for providing an advertising medium with the use of indicia on the insulator.

### PRIORITY CLAIM

This application claims priority to previously filed U.S. Provisional Application Ser. No. 61/118,377, filed on Nov. 26, 2008.

### FIELD OF THE INVENTION

The field of the invention is an insulator apparatus and system for a beverage container. More specifically, the field of invention is for an apparatus and a system for insulating a cup with a preformed and pre-packaged insulator.

### BACKGROUND

Cups, bottles and containers have utilized insulator systems for years. The insulation helps keep beverages contained within these receptacles warm or cold, depending on the desires of the individual user. Additionally, the insulator may also help advertise the product to other potential consumers. Many of these prior art insulators on cups, bottles and containers are multi-colored and have different indicia printed thereon which contain information about the insulator or may be sponsored by a particular company that may contain names, brands, colors, bar codes, ingredients and the like.

One of the primary problems with insulator systems is that they are rather cumbersome and come in only a few configurations. For example, many coffee outlet chains produce and utilize an insulator which may only cover a portion of the cup held by the consumer. This insulator is primarily designed to keep the warmth of the cup from affecting the holder of the cup and not to actually keep the contents of the cup warm. The problem with this type of insulator system is that it has little to no effect on the temperature of the cup. Furthermore, another problem with this type of insulator is that they tend to only cover a portion of the cup and not the entirety of it. Moreover, this type of coffee insulator takes up a significant amount of space to store. Therefore, many of these coffee shop operators fold them prior to use on their cups to maximize space.

Other various types of insulators will also be contemplated including the foam insulators that are commonly used for cold beverages. These foam insulators are typically of a pre-determined size and fit around the generally accepted size for most retail beverages including soda cans, beer cans and beer bottles. An advantage to these insulator units is that they typically cover the entirety of the bottles and/or cans and may also shield the user from the temperature of the actual container. For example, if a can is very cold, the foam insulator would allow for the user to handle the can without the possibility of their hands becoming cold from contact with the can itself. However, a problem with this type of insulator is that they are very cumbersome to carry around when a user desires to have this type of insulator. Further, they take up considerable space if and when a user desires to carry this insulator around for use. Moreover, with continued use, the foam of the insulator breaks down and eventually fluffs off the insulator, making the entire assembly less useful and aesthetically unpleasing. Furthermore, because these insulators take up considerable space, many users do not desire to carry them around, and thus have no way of protecting their drink from environmental temperatures and further, no way to protect themselves against the extreme temperatures of the receptacle.

Therefore a need exists for an improved insulator system which is efficient at both keeping the environmental temperatures away from the beverage, and at the same time allowing for easy handling by the consumer. Moreover, a need exists for an improved insulator system which is pre-packaged to handle a plurality of sized beverages, is easy to install on the beverage and may be easily transported when desired by the individual. Moreover, a need exists for a pre-packaged insulator that is space efficient for use by an individual and may be a single use application which may be thrown away by the individual user after use.

### SUMMARY OF THE INVENTION

The present invention provides an apparatus and a system for insulating a receptacle including a cup, bottle and/or container. Additionally, the present invention provides an apparatus and system for providing a pre-packaged, efficient and easily transported insulator which may be utilized in a single use fashion and may be easily applied to a beverage container for insulation and easy handling of same. Moreover, the present invention may be easily applied to the receptacle by rolling the insulator onto the beverage container. Further, the present invention may allow an advertising medium to be located on the insulator apparatus.

To this end in an exemplary embodiment, a beverage insulator apparatus is provided. The apparatus has a pre-packaged insulator device having at least an inside portion and an outside portion. Additionally, the beverage insulator apparatus has an insulator device having a lip portion, an opening and a bottom portion adapted for fitment around the bottom of a beverage container. Further, the apparatus has a pre-packaged insulator which is packaged in a wrapping for use by an individual consumer.

In an exemplary embodiment, the insulator has a lip portion constructed of silicon rubber for easy gripping by the individual end user.

In an exemplary embodiment, the insulator has a bottom portion constructed of lycra for absorption of condensation.

In an exemplary embodiment, the insulator is adapted to be rolled onto the outside edge of the beverage.

In an exemplary embodiment, the insulator is a single use application.

In an exemplary embodiment, the insulator may have pre-printed indicia thereon and may be rolled onto the outside of a beverage container.

In an exemplary embodiment, the insulator has an inside portion having pre-printed indicia thereon and a outside portion whereby the outside portion has pre-printed indicia printed thereon.

In an exemplary embodiment, the insulator has an inside portion having pre-printed indicia thereon and an outside portion whereby the outside portion has pre-printed indicia printed thereon, the inside portion and the outside portion are reversible wherein the insulator may be applied to the receptacle to effect that either one of the inside portion or outside portion may be viewable to the end user.

In an exemplary embodiment, the apparatus has a lip whereby the lip is rolled away from the bottom portion of the receptacle toward the top portion of the receptacle.

In an exemplary embodiment, the apparatus has an inside portion and an outside portion whereby the inside portion and the outside portion have a non-slip material thereon to allow for easier grip for both the user and to the receptacle.

In an exemplary embodiment, the apparatus has a lip that extends horizontally away from the side wall of the receptacle.

To this end, in an exemplary embodiment of the present invention, a method of applying an insulator to a receptacle, the method comprising the steps of: providing a pre-packaged insulator device having at least an inside portion and an outside portion; providing a beverage container having at least a lip area which extends away from the side wall of the beverage container; providing the insulator device with at least a lip portion, an opening, and a bottom portion adapted for fitment around the bottom of a beverage container; and pre-packaging the insulator in a wrapping for use by an individual consumer.

In an exemplary embodiment, the method further comprises the step of: removing the insulator from the wrapping and placing the bottom of the beverage container within the opening of the insulator device.

In an exemplary embodiment, the method further comprises the step of: rolling the lip of the insulator device up the side wall of the beverage container whereby the bottom portion of the device adapts to the bottom of the beverage container and the lip rolls up the side wall of the beverage container, extending the insulator device up the side wall.

In an exemplary embodiment, the method further comprises the step of: rolling the lip of the insulator device up the side wall until the lip is adjacent to the lip area of the beverage container whereby the lip area of the beverage container precludes further movement of the lip portion beyond the lip area of the beverage container.

In an exemplary embodiment, the method further comprises the step of: providing a non-slip surface on the inside and outside portions of the insulator device for easy handling of the insulator device when adapted to the beverage container.

In an exemplary embodiment, the method further comprises the step of: allowing for removal of the insulator device from the beverage container by rolling the device down the side walls of the beverage container until removed.

In an exemplary embodiment, the method further comprises the step of: allowing removal of the insulator device by simply tearing away the insulator device from the side walls of the beverage container.

In an exemplary embodiment, the method further comprises the step of: providing an insulator with an inside portion having pre-printed indicia thereon and an outside portion having pre-printed indicia printed thereon, the inside portion and the outside portion being reversible whereby the insulator may be applied to the beverage container such that either one of the inside portion or outside portion may be viewable to the end user.

In an exemplary embodiment, the method further comprises the step of: providing a lip portion constructed of a silicon rubber for gripping by the individual end user.

Among the many different possibilities contemplated, the system may allow for multiple configurations of the insulator about the cup and/or container.

Additionally, in an exemplary embodiment, the system may be configured to be easily applied to and removed from the container.

In another exemplary embodiment, it is contemplated that the system may be configurable to have indicia thereon for advertising and promotional purposes.

In yet another exemplary embodiment, it is contemplated that the system may be configurable to have an insulator which may have a label having a plurality of colors and indicia thereon.

A further exemplary embodiment contemplates that the insulation system may be configurable to fit around a plurality of different shaped and dimensioned containers including those with unconventional shapes and sizes.

In another exemplary embodiment, it is contemplated that the system may be pre-packaged to efficiently be transported from one place to another.

Still another exemplary embodiment is to provide an insulation system whereby the insulation may be constructed of any suitable material such as paper, wax, plastic, foam and the like.

In yet another exemplary embodiment, an insulation system may be provided whereby the insulation system may be constructed of silicon rubber on top for grip and lycra to capture condensation.

Further, a contemplated embodiment of the system may have an insulation system which may protect against temperature changes and may further capture condensation and perspiration of the beverage.

Additionally, in an exemplary embodiment, the apparatus may be constructed of at least two materials which make up the insulator. In an exemplary embodiment the materials may be a rubber portion and a lycra portion.

In yet another exemplary embodiment, it is contemplated that the insulator may be pre-packaged into a generally planar state whereby the insulator may be rolled onto a beverage receptacle when desired by the individual user.

Yet another exemplary embodiment of the present invention may include an insulator which may be unrolled onto the receptacle and easily rolled back off the beverage receptacle when desired by the user and thrown away after a single use.

In an exemplary embodiment of the present invention, an apparatus and a system for insulation of a beverage is provided wherein a label is printed onto the insulator prior to attachment to the receiving cup.

Another exemplary embodiment of the present invention may include an apparatus and a system for insulating a beverage whereby the insulator may be snap-fitted to a beverage and easily removed when desired by the individual user.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of the invention illustrating the system in an exemplary embodiment of the present invention.

FIG. 2 is a top view of the invention illustrating the system in an exemplary embodiment of the present invention.

FIG. 3 is a side view of the invention illustrating the system in an exemplary embodiment of the present invention.

FIG. 4 is a bottom view of the invention illustrating the apparatus in an exemplary embodiment of the present invention.

FIG. 5 is a side view illustrating the invention after removing it from packaging and before inserting it onto the beverage container in an exemplary embodiment of the present invention.

FIG. 6 is an illustration of the insulator apparatus being applied to a receptacle in an exemplary embodiment of the present invention.

### DETAILED DESCRIPTION OF THE INVENTION

The following description of a preferred embodiment(s) is merely exemplary in nature and is in no way intended to limit the invention, its application, or uses. For ease of description, only one exemplary embodiment is herein described in detail. However, it should be understood that a person of ordinary skill in the art would contemplate that any of a plurality of embodiments may utilize the same or similar features to produce the desired results.

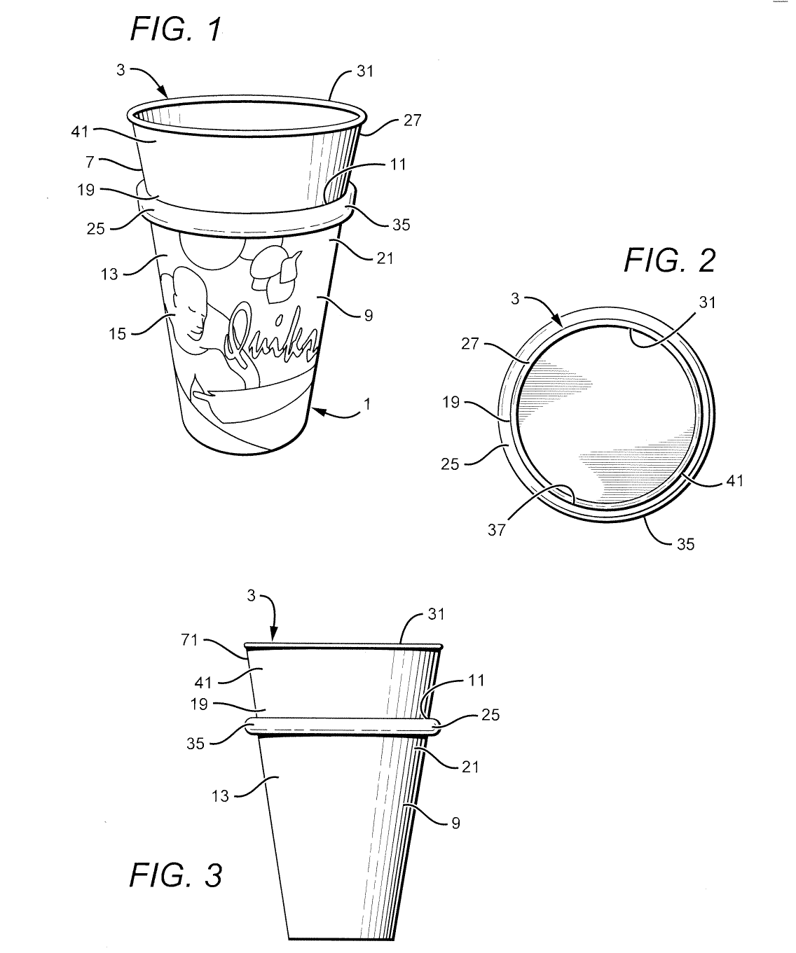

Referring now to FIG. 1, the figure illustrates the insulator 1 which is designed to fit around a receptacle 3. In an exemplary embodiment, the receptacle 3 may be a coffee cup. However, it should be understood that any suitable receptacle 3 may be utilized including a beer mug, cups, bottles, containers, water bottles, soda bottles or any other receptacle 3 capable of holding a liquid, solid or gaseous substance.

FIG. 1 illustrates the receptacle 3 whereby the receptacle 3 may be in the form of a coffee cup. As is well know coffee is best served hot, and often times, the receptacle 3 that holds coffee or other warm substances such as tea, hot chocolate and the like are often not thick enough, thereby the outside portion 7 of the receptacle 3 is often too hot for an individual to hold. Thereby, the sleeve (not shown) was developed to cover the receptacle 3 during use which provides an additional layer of insulation for the receptacle 3 and at the same time allows for the individual user to handle the receptacle 3 without fear of burning their hands. However, one problem with these prior art sleeves are that they only cover a portion of the receptacle 3 and are easily removed from the receptacle without much effort. Many times the sleeve will fall off the receptacle contrary to the desires of the user.

The present invention provides an insulation portion 9 which may be easier to apply to the receptacle before and during use. Moreover, the insulation portion 9 may be multiple sided having both an inside portion 11 and an outside portion 13. It is contemplated that either of the inside portion 11 or the outside portion 13 may have printed indicia 15 thereon. The printed indicia 15 may be advertising or other promotional material that may be added by the seller of the receptacle 3. It is contemplated that the insulation portion 9 may be pre-printed with advertising and other promotional material prior to applying the insulation portion 9 to the receptacle 3. It is further contemplated that the inside portion 11 may have indicia printed thereon. The insulation portion 9 may have this inside portion 11 which may be in contact with the outside edge 19 of the receptacle 3. However, it is contemplated that the inside portion 11 may be reversed or turned inside out and become the outside portion 13. In this way, the outside portion 13 would become the inside portion 11 and the indicia 15 printed would not be visible as it would be in contact with the outside edge 19 of the receptacle 1. Thereby the insulation portion 9 is reversible and either the inside portion 11 or the outside portion 13 may be viewed by an individual depending on how the insulation portion 9 is applied to the receptacle.

Further, the insulation portion 9 may be utilized to keep condensation off the hands of the individual user, and may also be utilized to insulate the user from excessive heat or cold coming from the liquid contained within the receptacle 3.

FIGS. 1 and 2 further illustrate the top area 21 of the insulation portion 9. The top area 21 may be associated with at least a lip 25 whereby the lip 25 may comprise a larger mass than the rest of the insulation portion 9. It is contemplated that the lip 25 may be positioned at or near the top portion 27 of the receptacle. Further, because the lip 25 is a larger mass than the rest of the insulation portion 9, the lip 25 will be easier for a user to handle and makes insertion of the entire insulation portion 9 easier as the lip 25 is typically inserted onto the receptacle 3 prior to any of the inside or outside portions 13, 11.

FIG. 2 illustrates a top view of the receptacle 3 whereby the lip 25 extends outwardly from the outside edge 19 of the receptacle 3. The receptacle 3 may also have a lip 31 located on the top area 27 of the receptacle 3. The lip 31 may prevent the lip 25 of the insulator portion 9 from extending beyond the lip 31 of the receptacle 3 and may keep the insulator portion 9 in place without the need to worry that the insulator portion 9 will accidentally be removed from the receptacle 3. Further lip 25 of the insulator portion 9 may be constructed of a non-slip material 35 which is located on the inside edge 37 of the lip 25 to prevent the lip 25 from moving up or down the receptacle 3 after appropriate placement of the lip 25 at a specific location on the receptacle 3 by the individual user. In operation, the user may slip the lip 25 around the bottom portion 39 of the receptacle and roll the insulator portion 9 up the side walls 41 of the receptacle 3 until the desired location of the lip 25 is reached. In an exemplary embodiment, the user may slide the insulator portion 9 to where the lip 25 may be adjacent to the lip 31 of the receptacle 3 whereby the lip 31 of the receptacle will preclude further extension of the insulator portion 9 beyond the lip 31 of the receptacle 3.

FIGS. 3 and 6 illustrates the insulator portion 9 about the receptacle 3. As detailed above and further illustrated in FIG. 5, the insulator portion 9 may be distributed in packaging that is very thin and discrete making it easy to transport, store and utilize. In an exemplary embodiment, the insulator portion 9 may be contained within a wrapping (not shown) until the user desires to utilize the insulator portion 9. The wrapping may be packaged in a thin piece of plastic or other material that may be easily opened and used by an end user. Moreover, the thin and efficient wrapping and/or packaging may make it easy to use as a promotional piece by advertisers or marketers to market or promote a product, brand, or the like. They may be easily distributed to potential users and used by the individual user at their own desire. As illustrated above, the insulator portion 9 may have at least an inside and outside portion 13, 13 whereby both the inside portion 11 and the outside portion 13 may have printed indicia thereon whereby the indicia 15 is also be effective as advertising and promotional material.

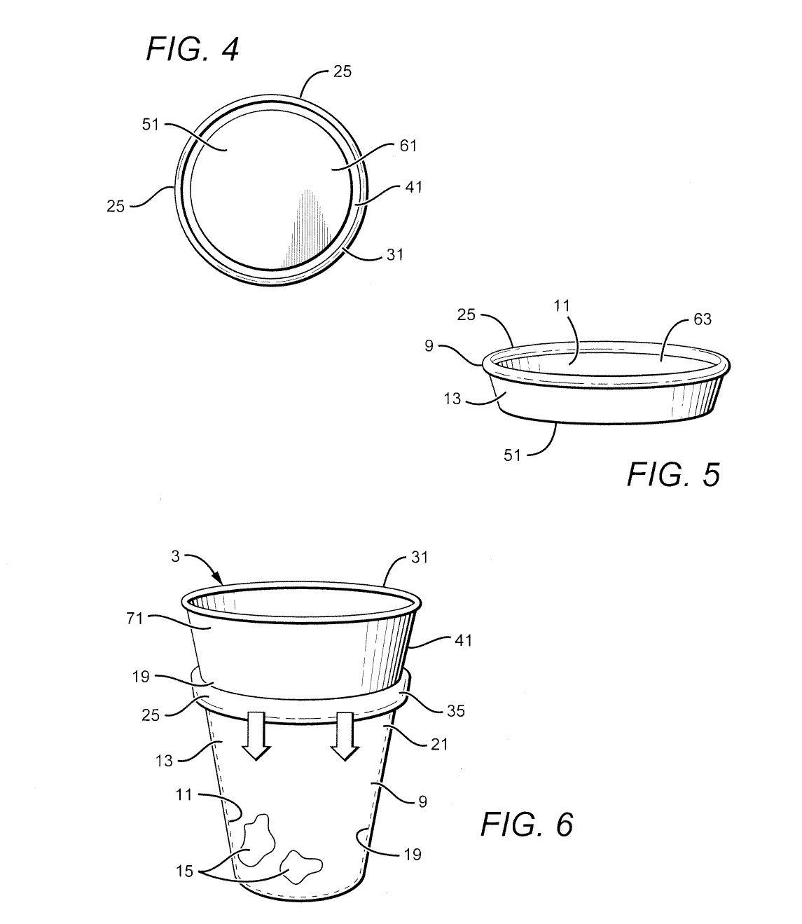

FIG. 4 illustrates the a bottom view of the receptacle 3 whereby the bottom 61 of the receptacle is enclosed and completely encompassed by the bottom portion 51 of the insulator portion 9. As the bottom portion 51 fits around the bottom 61 of the receptacle, the lip 25 is rolled up the side walls 41 of the receptacle 3 until the lip 25 of the apparatus reaches the lip 31 of the receptacle 3 whereby the lip 31 of the receptacle 3 precludes further upward movement of the lip 25 of the apparatus as can be seen in FIG. 4, the lip 25 of the apparatus extends horizontally away from the side walls 41 of the receptacle 3 and may be used to grip the apparatus and the receptacle 3 as a whole for easier use. The lip 25 may also facilitate easier removal and insertion of the insulator portion 9 to the receptacle 3 because of its width and size.

FIG. 5 also illustrates whereby the insulator portion 9 may be completely rolled up such that only the lip 25 and the bottom portion 51 of the insulator portion 9 may be accessible at first. The bottom portion 51 may fit about the bottom 61 (see FIG. 4) of the receptacle whereby the lip 25 may extend around the outside walls 42 of the receptacle 3. Once the bottom portion 51 of the insulator portion 9 is fitted about the bottom 61 of the receptacle, the lip 25 is rolled up the receptacle as shown in FIGS. 3 and 6. Thereby the level of insulator portion 9 adapted to the receptacle 3 is determined by how far the individual rolls up the lip 25 onto the outside edge 19 of the receptacle 3. In an exemplary embodiment, the insulator portion 9 may be constructed of a thin plastic, latex or polyethylene material such that it easily extends along the outside edge 19 of the receptacle 3. Additionally, it is contemplated that the insulator portion 9 may be thin and malleable such that the insulator portion 9 may conform to the shape of the receptacle 3 in the event that the receptacle 3 is not a standard cup shape. For example, if the receptacle 3 is a bottle having an odd shape, the material of the insulator portion 9 may allow for the insulator portion 9 to take the shape of the bottle and still retain its original function as an insulator. Further, it is contemplated that either of the inside portion 11 or the outside portion 13 may have a non-slip surface which may allow the user to easily handle the insulator portion 9 without the fear of the entire receptacle 3 slipping from their hands. It should be understood that this non-slip surface may be applied to either the inside portion 11 and/or the outside portion 13, and in an exemplary embodiment, it may be applied to both the inside portion 11 and the outside portion 13. The advantage of applying the non-slip surface to both inside and outside portions 11, 13, is that the user holding the outside portion 13 may have the added benefit of the insulator portion 9 being easy to handle without slipping from their grip and the inside portion 11 may allow the insulator portion 9 to adhere to the outside edge 19 of the receptacle 3 without worrying that the insulator portion 9 will slip away from the outside edge 19 of the receptacle 3.

FIG. 5 also illustrates an opening 63 whereby a receptacle 3 having a bottom portion 61 may fit into the opening 63 and whereby the lip 25 of the insulator portion 9 may extend around the bottom 61 of the receptacle 3 and may be rolled up the side walls 41 of the receptacle for use.

FIGS. 3 and 6 illustrate the insulator portion 9 attached to the outside edge 19 of the receptacle 3. FIG. 6 specifically shows the insulator portion 9 completely surrounding the receptacle 3 whereby the only visible portion of the receptacle 3 is the top area 71 and the lip 31 of the receptacle 3. It is contemplated that removal of the insulator portion 9 may proceed in a similar fashion as its placement on the receptacle 3. In an embodiment, the insulator portion 9 may be rolled down the receptacle 3 until it has been removed from the side wall 41 of the receptacle. It is contemplated that the insulator portion 9 may be a single use application whereby it may be disposed of after use. However, because of the thin nature of the insulator portion 9, the insulator portion 9 may be torn away from the side wall 41 of the receptacle 3 making it easier to remove without the need to roll it down the side wall 41.

The above-described device may be altered by means known in the art without departing from the spirit and scope of this invention.

The inventive subject matter, therefore, is not to be restricted except in the spirit of the appended claims. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the invention has been described in what is presently considered to be an exemplary embodiment, many variations and modifications will become apparent to those skilled in the art. Accordingly, it is intended that the invention not be limited to the specific illustrative embodiment, but be interpreted within the full spirit and scope of the appended claims.

I claim:

1. A beverage insulator apparatus, the apparatus comprising:
a pre-packaged insulator device having at least an inside portion and an outside portion;
said insulator device having a lip portion, an opening and a bottom portion adapted for fitment around the bottom of a beverage container; and
said pre-packaged insulator packaged in a wrapping for use by an individual consumer.

2. The apparatus described in claim 1 wherein said insulator has a lip portion constructed of silicon rubber for easy gripping by the individual end user.

3. The apparatus described in claim 1 wherein said insulator has a bottom portion constructed of lycra for absorption of condensation.

4. The apparatus described in claim 1 wherein said insulator is adapted to be rolled onto the outside edge of the beverage.

5. The apparatus described in claim 1 wherein said insulator is a single use application.

6. The apparatus described in claim 1 wherein said insulator has pre-printed indicia thereon and may be rolled onto the outside of a beverage container.

7. The apparatus described in claim 1 wherein the insulator has an inside portion having pre-printed indicia thereon and a outside portion whereby the outside portion has pre-printed indicia printed thereon.

8. The apparatus described in claim 1 whereby the insulator has an inside portion having pre-printed indicia thereon and an outside portion whereby the outside portion has pre-printed indicia printed thereon, the inside portion and the outside portion are reversible wherein the insulator may be applied to the receptacle to effect that either one of the inside portion or outside portion may be viewable to the end user.

9. The apparatus described in claim 1 further comprising: the apparatus having a lip whereby the lip is rolled away from the bottom portion of the receptacle toward the top portion of the receptacle.

10. The apparatus described in claim 1 wherein the inside portion and the outside portion have a non-slip material thereon to allow for easier grip for both the user and to the receptacle.

11. The apparatus described in claim 1 wherein the lip portion of the apparatus extends horizontally away from the side wall of the receptacle.

12. A method of applying an insulator to a receptacle, the method comprising the steps of:
providing a pre-packaged insulator device having at least an inside portion and an outside portion;
providing a beverage container having at least a lip area which extends away from the side wall of the beverage container;
providing the insulator device with at least a lip portion, an opening, and a bottom portion adapted for fitment around the bottom of a beverage container; and
pre-packaging the insulator in a wrapping for use by an individual consumer.

13. The method of claim 12 further comprising the step of:
removing the insulator from the wrapping and placing the bottom of the beverage container within the opening of the insulator device.

14. The method of claim 12 further comprising the step of:
rolling the lip of the insulator device up the side wall of the beverage container whereby the bottom portion of the device adapts to the bottom of the beverage container and the lip rolls up the side wall of the beverage container, extending the insulator device up the side wall.

15. The method of claim 12 further comprising the step of:
rolling the lip of the insulator device up the side wall until the lip is adjacent to the lip area of the beverage container whereby the lip area of the beverage container precludes further movement of the lip portion beyond the lip area of the beverage container.

16. The method of claim 12 further comprising the step of:
providing a non-slip surface on the inside and outside portions of the insulator device for easy handling of the insulator device when adapted to the beverage container.

17. The method of claim 12 further comprising the step of:
allowing for removal of the insulator device from the beverage container by rolling the device down the side walls of the beverage container until removed.

18. The method of claim 12 further comprising the step of:
allowing removal of the insulator device by simply tearing away the insulator device from the side walls of the beverage container.

19. The method of claim 12 further comprising the step of:
providing an insulator with an inside portion having pre-printed indicia thereon and an outside portion having pre-printed indicia printed thereon, the inside portion and the outside portion being reversible whereby the insulator may be applied to the beverage container such that either one of the inside portion or outside portion may be viewable to the end user.

20. The method of claim 12 further comprising the step of:
providing a lip portion constructed of a silicon rubber for gripping by the individual end user.
